(19) United States
(12) Patent Application Publication
(10) Pub. No.: US 2012/0030307 A1
(43) Pub. Date: Feb. 2, 2012

(54) NETWORK SYSTEM

(76) Inventors: Mitsunori Kubo, Tokyo (JP); Takayuki Nakatomi, Tokyo (JP)

(21) Appl. No.: 12/597,240

(22) PCT Filed: Apr. 24, 2008
(86) PCT No.: PCT/JP08/57986

§ 371 Date: Oct. 23, 2009

(30) Foreign Application Priority Data
Apr. 26, 2007 (JP) 2007-116475

(51) Int. Cl. G06F 15/173; G06F 13/00; G06F 15/16

(52) U.S. Cl. 709/217; 709/223

(57) ABSTRACT

There is provided a network system which is capable of carrying out a communication process most efficiently all the time, when a portable terminal has moved.

The network system includes a plurality of servers which carry out a predetermined processing, two or more than two resource routers which are connected to the plurality of servers, and a client which communicates with at least any one of the plurality of servers via the resource routers. One of the resource routers, at a predetermined timing, selects and switches to a server which carries out an optimum processing with respect to the client, from among the plurality of servers.

### TECHNICAL FIELD

The present invention relates to a network system.

### Background Art

As it has been indicated in a non-patent literature 1 (a client-server system) has hitherto been known. Here, a connection with a network is carried out by using a client. In the client-server system, a concentration of load to a server becomes a problem. Therefore, a plurality of servers are to be prepared. Moreover, a load distributing unit is inserted between the client and the server. The client makes an access with the server via the load distributing unit. Accordingly, distribution of a process to one of the servers in which, a plurality of load distributing units exists is carried out.

Non-patent literature: ‘Basics of network for SE’ by ‘Shin-ichi Akiyama’ (SE no tame no nettowaku no kihon), published by ‘SHOEISHA’ on Aug. 2, 2005

### Disclosure of Invention

### Technical Problem

In a conventional client-server system, a performance of each server and the number of servers to be installed are determined upon predicting in advance by a system administrator. Therefore, it is not possible to deal with a load which is beyond prediction. Moreover, the server which processes is fixed. For instance, when a user having a portable terminal moves, access point is switched to one after another. At this time, a back-bone of communication is switched. Therefore, the communication is possible continuously, whereas, the server which carries out processing is fixed. As a result, there arises a problem of a decrease in a processing speed.

The present invention is made in view of the abovementioned circumstances, and an object of the present invention is to provide a network system which is capable of carrying out processing most efficiently all the time, by selecting an optimum server according to the situation.

### Technical Solution

To solve the abovementioned issues, and to achieve the object, there can be provided a network system including a plurality of first arithmetic processing units which carry out a predetermined processing,

a second arithmetic processing unit which is connected to the plurality of first arithmetic processing units, and

a third arithmetic processing unit which communicates with at least one of the plurality of first arithmetic processing units via the second arithmetic processing unit, and

the second arithmetic processing unit, at a predetermined timing, selects and switches to the first arithmetic processing unit which carries out an optimum processing with respect to the third arithmetic processing unit, from among the plurality of first arithmetic processing units.

Moreover, according to a preferable aspect of the present invention, it is desirable that the network system includes

a plurality of first arithmetic processing units which carry out a predetermined processing,

two or more second arithmetic processing units which are connected to the plurality of first arithmetic processing units, and

a third arithmetic processing unit which communicates with at least one of the plurality of first arithmetic processing units via the second arithmetic processing unit, and

that the second arithmetic processing unit, at a predetermined timing, selects and switches to the first arithmetic processing unit which carries out an optimum processing with respect to the third arithmetic processing unit, from among the plurality of first arithmetic processing units.

Moreover, according to a preferable aspect of the present invention it is desirable that when the second arithmetic processing unit to which the third arithmetic processing unit connects is switched one after another, with a movement of the third arithmetic processing unit, the second arithmetic processing unit which is connected to the third arithmetic processing unit, based on connection information when another second arithmetic processing unit was connected to the third arithmetic processing unit, selects the first arithmetic processing unit which carries out an optimum processing with respect to the third arithmetic processing unit.

Moreover, according to a preferable aspect of the present invention, it is desirable that the first arithmetic processing unit passes data to one of the other first arithmetic processing units.

Moreover, according to a preferable aspect of the present invention, it is desirable that the first arithmetic processing unit passes data to the plurality of the other first arithmetic processing units.

### Advantageous Effects

A network computer according to the present invention shows an effect that it is possible to carry out a communication process most efficiently all the time, when a portable terminal has moved.

### BRIEF DESCRIPTION OF THE DRAWINGS

FIG. 1 is a diagram showing a schematic structural view of a network computer according to a first embodiment of the present invention;

FIG. 2 is a diagram explaining a protocol which registers a function of a server in a resource router;

FIG. 3A is a diagram explaining a protocol between two resource routers;

FIG. 3B is a diagram explaining a protocol between two resource routers;

FIG. 4 is a diagram explaining a protocol when a client connects to the server;

FIG. 5 is a flowchart showing a procedure for server retrieval;

FIG. 6 is a diagram explaining a protocol between the client and the resource router;

FIG. 7 is a diagram explaining a protocol when the server is switched;

FIG. 8 is a flowchart showing a procedure when the server is switched;

FIG. 9 is a diagram explaining a protocol of an address change due to movement of the client;

FIG. 10 is a diagram showing a schematic structure of a network computer (network system) according to a second embodiment of the present invention; and

FIG. 11 is a diagram showing a schematic structure of a network computer according to a third embodiment of the present invention.

### EXPLANATION OF REFERENCE

100 Client
210 Resource router
215 Access point
220 Resource router
225 Access point
320, 321, 322 Server
230 Resource router
235 Access point
310, 311, 312, 313, 314, 315 Server
320, 321, 322 Server
330, 331, 332 Server
U User

### Best Mode for Carrying Out the Invention

Exemplary embodiments of a network computer according to the present invention will be described below in detail by referring to the accompanying diagrams. However, the present invention is not restricted to the embodiments described below.

### First Embodiment

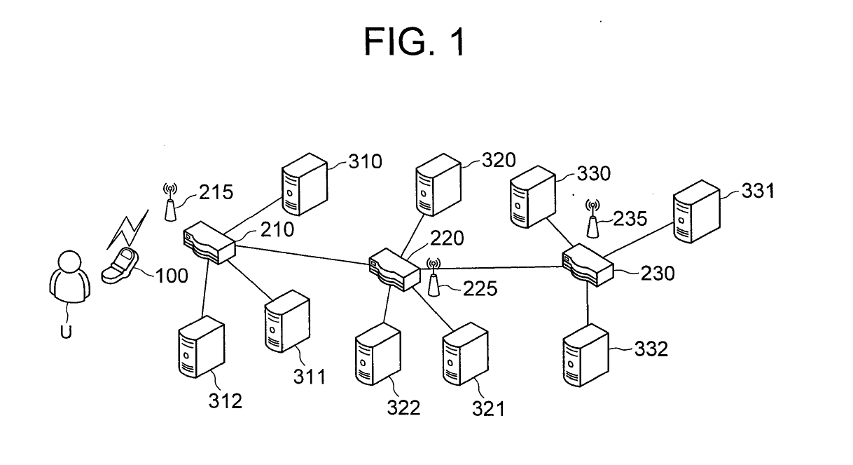

FIG. 1 shows a schematic structure of a network computer according to a first embodiment of the present invention. A user U has a client 100. Moreover, three servers 310, 311, and 312 are connected to a resource router 210. The client 100 carries out communication with the resource router 210 via an access point 215 which is nearest.

Each of the servers 310, 311, and 312 provides a predetermined function. The predetermined functions are functions such as factorization, network storage, and decoding of a moving image. Moreover, the client 100 is a portable terminal which uses the function provided by each of the servers 310, 311, and 312. The client 100 is a notebook-sized personal computer, a PDA, and a portable telephone etc. The user U carries around the client 100, and uses a function provided by the server 310 etc.

Moreover, the access point 215 is a base unit of wireless LAN or a base station of a portable telephone. The resource router 210 is a relay equipment of a network. A resource control program which will be described later is operated in the resource router 210.

The resource router 210 regulates the plurality of servers 310, 311, and 312. Similarly, a resource router 220 regulates a plurality of servers 320, 321, and 322. A resource router 230 regulates a plurality of servers 330, 331, and 332.

An access point 225 is provided to the resource router 220. An access point 235 is provided to the resource router 230. In the first embodiment, the client 100 connects to a server which provides a target function, via three resource routers 210, 220, and 230.

A server corresponds to a first arithmetic processing unit. A resource router corresponds to a second arithmetic processing unit. A client corresponds to a third arithmetic processing unit. Moreover, in the present invention, the first arithmetic processing unit, the second arithmetic processing unit, and the third arithmetic processing unit are capable of carrying out the respective functions alternately. For example, the server may also become the resource router or the client.

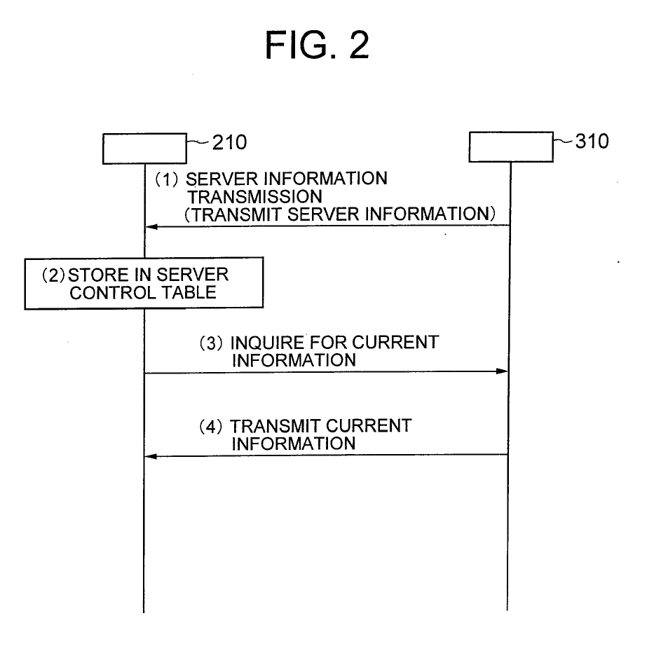

Next, a protocol when the server registers a function of the server in the resource router will be described below by referring to FIG. 2. For example, the server 310 registers in advance a function that can be provided, in the resource router 210.

Here, the following points are let to be preconditions.

The resource router 210 has already been started, and the resource control program is operated.

A network address of the resource router 210 has been set by a server administrator.

Retrieving a resource router in a network by broadcast, and the resource router which is responded, is selected.

In sequence (1), when the server 310 starts, the server 310 transmits information of the server 310 to the resource router 210. The server 310 lets the information to be transmitted to the resource router 210 to be subsequent static information, or in other words, information which does not change temporally.

Number of processors

Performance of processor

Type of processor (Pentium (registered trademark), MIPS, Dynamic reconfigurable etc.)

Memory capacity

Storage capacity

Operating system

Maximum speed of network interface

Function to be provided which is expressed in a numerical value

In sequence (2), the resource router 210 controls the information transmitted by storing in a server control table. In sequence (3), the resource router 210 inquires current information to the server 310. In sequence (4), the server 310 transmits a current state to the resource router 210.

In this manner, the resource router 210, for the server 310 which is registered, collects at an appropriate interval, dynamic information, or in other words, information which changes temporally.

Following information is available as the dynamic information.

Number of clients which are connected

Client ID (value which identifies the client) which is connected

Average CPU utilization factor in last one minute, for each connection

Number of bytes of data received and number of bytes of data transmitted in last one minute, for each connection

Usable memory capacity of each connection

Usable storage capacity

The resource router 210 controls static information as well as dynamic information of each of the servers 310, 311, and 312.

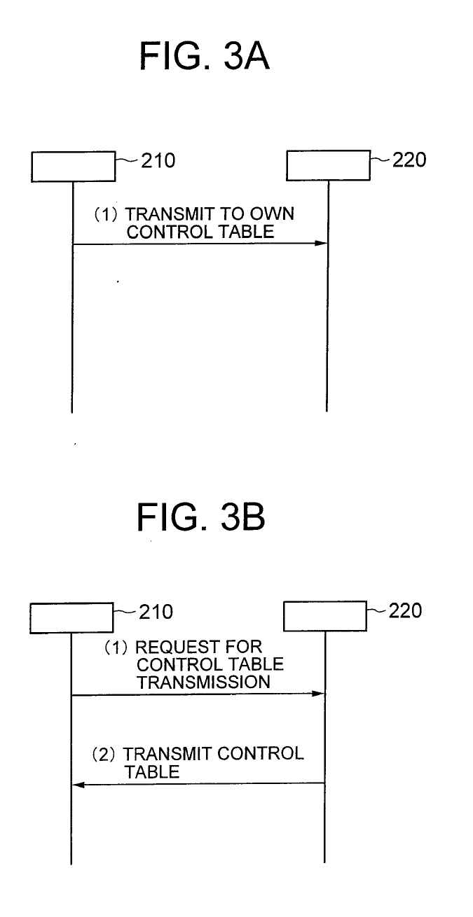

Next, protocols between the resource routers will be described below by referring to FIG. 3A and FIG. 3B. The resource router 210 is let to identify the adjacent resource router 220. The resource router adjacent to the resource router 210 is not restricted to one, and may be in a plurality.

In FIG. 3A, the resource router 210 transmits a table controlled by the resource router 210, to the adjacent resource router 220 at an appropriate time interval. The adjacent resource router 220 controls an adjacent resource router and a table. Therefore, the resource router 210 is capable of collecting information controlled by a resource router which is farther away.

Moreover, as shown in FIG. 3B, the resource router 210 sometimes makes a demand explicitly for information from the other resource router 220. In sequence (1) in FIG. 3B, the resource router 210 makes a demand for transmission of a control table to the resource router 220. In sequence (2), the resource router 220 transmits the control table to the resource router 210.

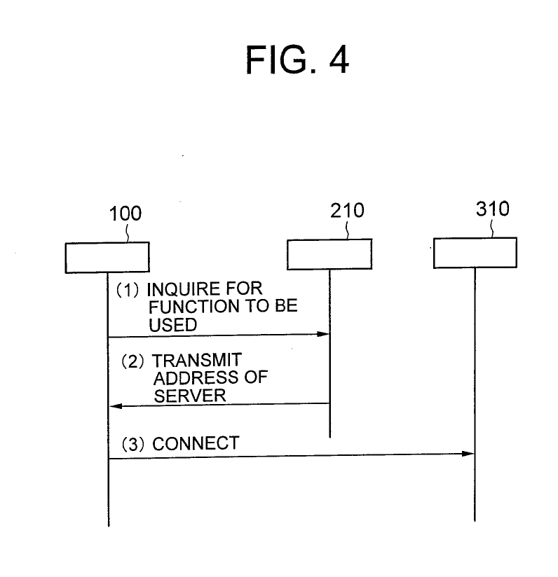

Next, a protocol between the client and the resource router in a state before using a server function will be described below by referring to FIG. 4.

In sequence (1), the client 100 inquires the resource router 210 for a predetermined function to be used. At this time, the function is designated by a number (numerical data). The resource router 210 retrieves a server provided with the predetermined function, by a procedure which will be described later. In sequence (2), the resource router 210 transmits an address of the server 310 which is provided with the function for which the request has been made.

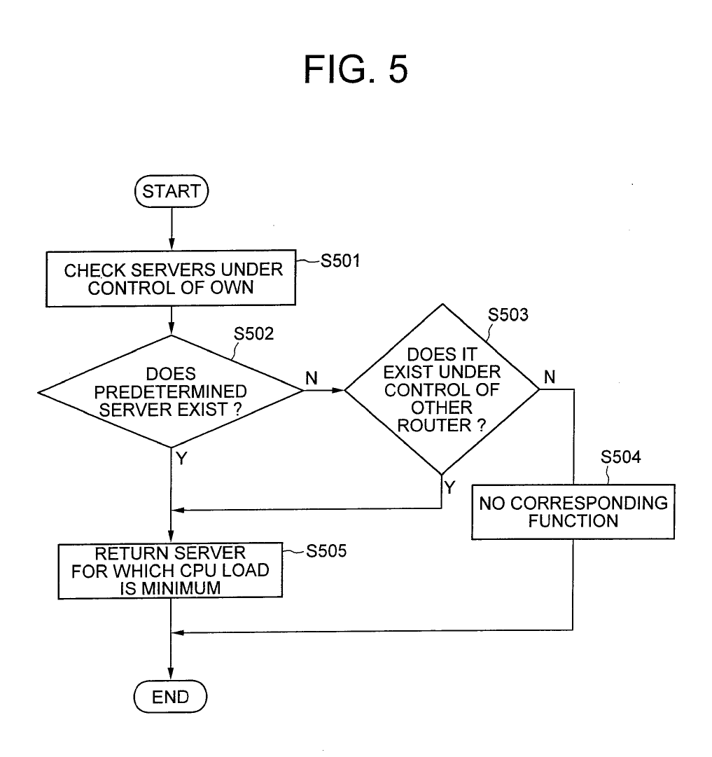

FIG. 5 is a flowchart showing a procedure for retrieving a server which is provided with a predetermined function. At step S501, the resource router 210 checks servers which are under the control of the resource router 210. Here, the numbers indicating the functions of the server are let to be disclosed in advanced. Examples of numbers indicating the functions are number 10000 for moving image compression and number 10001 for moving image expansion.

The resource router 210 refers to a table which is held. The resource router 210 retrieves whether the function for which the request has been made is provided by any of the servers. At step S502, a determination of whether or not a server which is provided with the predetermined function exists is made.

When a determination result at step S502 is affirmative (Yes), the resource router 210, transmits to the client 100, an address of a server from among the server retrieved, for which, a CPU load is the minimum. When the determination result at step S502 is negative (No), a determination of whether or not the server provided with the predetermined function exists under control of the other resource router is made.

When a determination result at step S503 is affirmative, the process advances to step S505. When the determination result at step S503 is negative, the function is assumed to be not there at step S504, and the process is terminated.

The client 100 connects to the server 310 of the address which has been transmitted. It is possible to determine communication protocols from this onward, depending on that function.

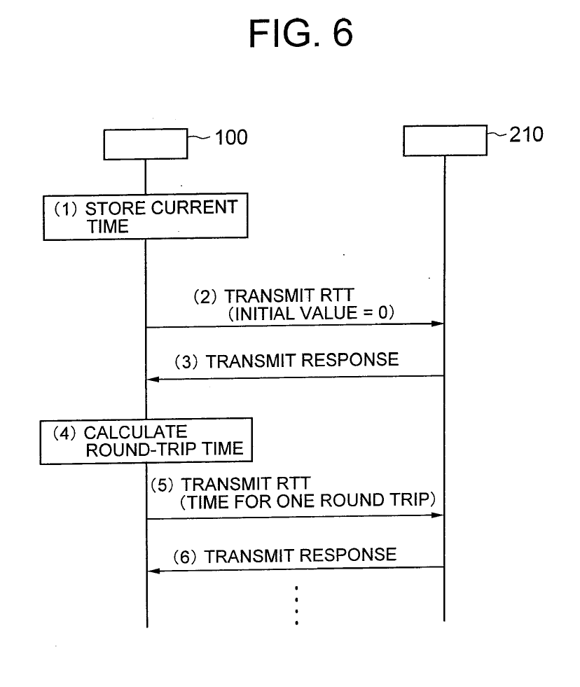

Next, a protocol between the client and the resource router during the use of server function will be described below by referring to FIG. 6.

The client 100 carries out the following communication with a resource router (not the resource router which is near) for which, that server has been assigned during the use of the function of the server. In sequence (1) in FIG. 6, the client 100 stores the current time.

In sequence (2), the client 100 transmits a round-trip time (RTT) to the resource router 210 as an initial value=0. In sequence (3), the resource router 210 carries out transmission of a response to the client 100.

The round-trip time (RTT) is time from which, data transmitted is received by a counterpart, till a response is returned from the counterpart and received.

In sequence (4), the client 100 calculates the round trip time based on the time stored, and the time at which the response transmitted has been received. In sequence (5), the client 100 transmits the round trip time (time for one round trip) to the resource router 210. In sequence (6), the resource router 210 returns a response transmission to the client 100. From here onward, the transmission of the round trip time and the transmission of the response are repeated at an appropriate interval.

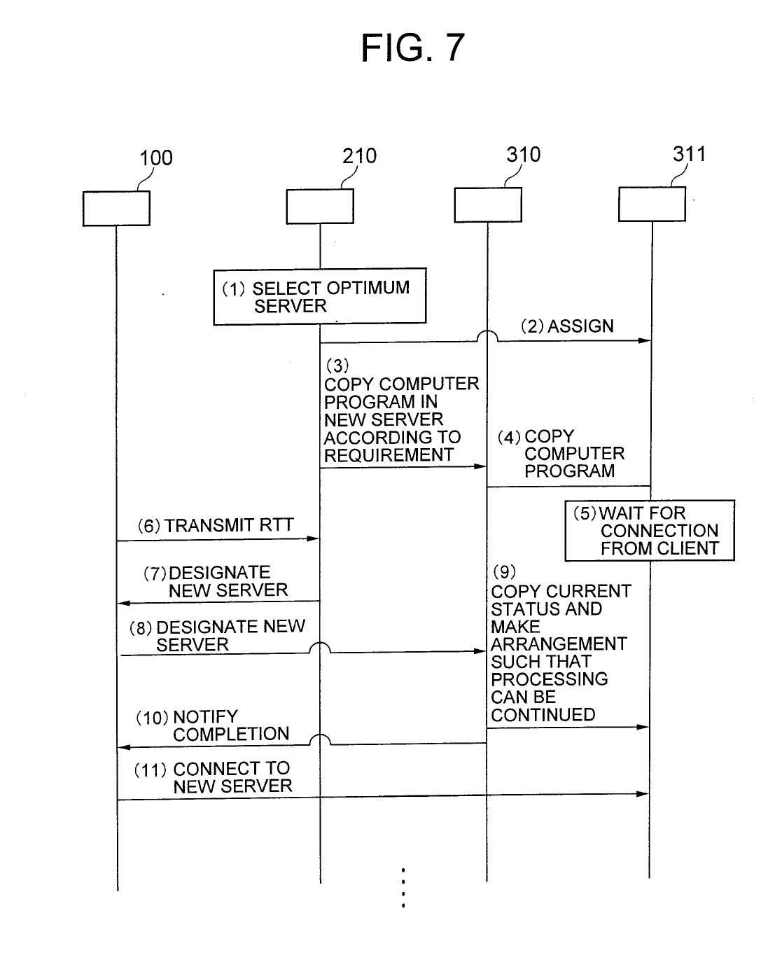

Next, a protocol when the client 100 switches the server to be used will be described below by referring to FIG. 7. The resource router 210 has information of servers of the resource router 210, and servers under control of resource routers around the resource router 210. Therefore, when a server more appropriate than the server which has been used currently by the client 100 is found, the server is switched upon giving instruction to the client 100.

Therefore, the resource router 210 monitors server information which has been updated constantly. Moreover, in sequence (1), the resource router 210 selects the optimum server for the client 100.

In sequence (2), the resource router 210 assigns the new server 311. In sequence (3), when a determination is made that the server is required to be updated, when the computer program which is being executed is not in the new server 311, the resource router 210 makes copy the computer program in the new server 311 from the current server 310.

In sequence (4), the current resource router 310 copies the computer program to the new resource router 311. The new server 311 waits for a connection from the client 100. In sequence (6), the client 100 transmits the round trip time to the resource router 210.

In sequence (7), the resource router 210 transmits a response information including a switching instruction which instructs the new server 311. In sequence (8), the client 100 transmits an address of the new server 311 to the current server 310.

In sequence (9), a processing status of the current server 310 is made to be copied in the new server 311. In sequence (10), the current server 310 transmits a notification of completion to the client 100. In sequence (11), he client 100 connects to the new server 311, and starts continuation of the process.

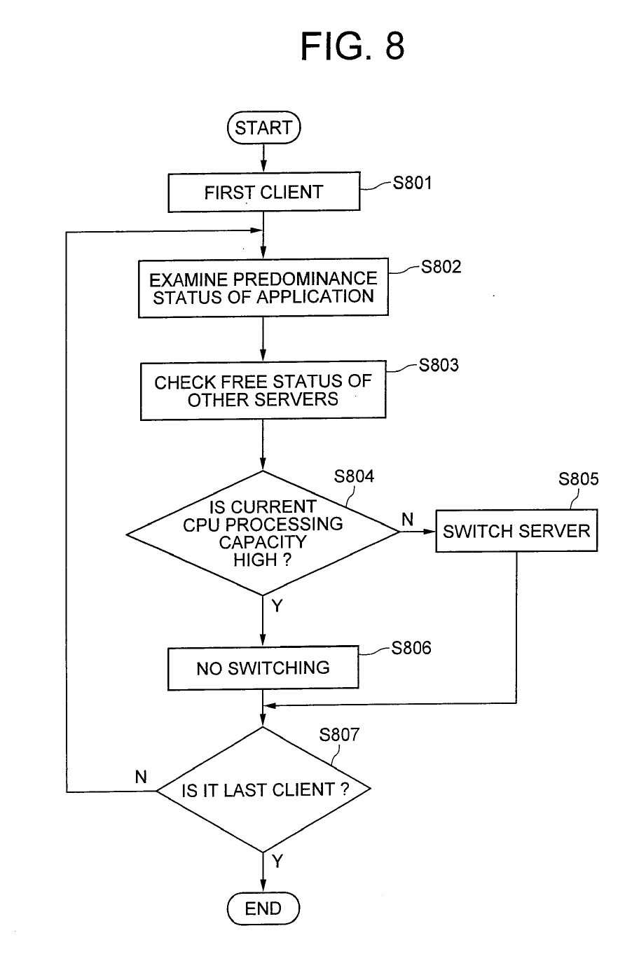

FIG. 8 is a flowchart showing a procedure of switching the server. An algorithm of the optimum server selection in the abovementioned resource router will be described below. Here, a state in which a plurality of clients are connected to the resource router is taken into consideration.

At step S801, an attention is focused on the first client from among the plurality of clients. At step S802, as to whether an application which is being executed in the server being used by the client is CPU-predominant or communication-predominant is examined based on information which is transmitted from the server.

The CPU-predominant means a case in which, communication data is less but calculations using a CPU are large. The examples are factorization and code-breaking. The network dominant means a case in which, the communication data is large, but the calculations are less. An example is network storage.

At step S803, in the other server, a checking of whether a CPU or a network is free is made. At step S804, a determination of whether or not a processing capacity of the current CPU is higher than a processing capacity of the CPU which is free is made.

When a determination result at step S804 is affirmative, at step S806, it is let to be without switching. At step S807, a determination of whether or not it is the last client is made. When a determination result at step S804 is negative, at step S805, the switching of server is carried out. Further, the process advances to step S807.

When a determination result at step S807 is affirmative, the process is terminated. When the determination result at step S807 is negative, the process advances to step S802. Further, the abovementioned procedure is repeated.

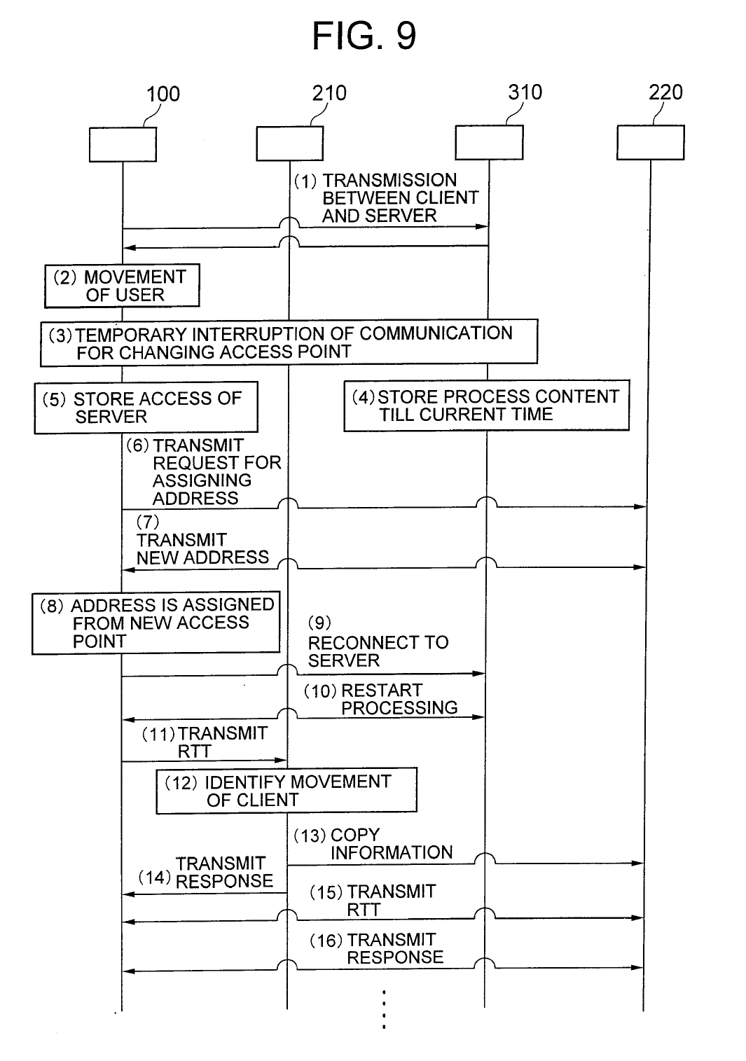

Next, a protocol of an address change of a server due to the movement of the client 100 will be described below by referring to FIG. 9. In FIG. 9, the resource router 210 is an original resource router. The server 310 is a server under control of the original resource router 210. Moreover, the resource router 220 is a resource router which is existed at a destination of movement of the client 100.

In sequence (1), the client 100 carries out communication with the resource router 310. In sequence (2), the client 100 moves. In sequence (3), the communication is interrupted temporarily for changing an access point.

In sequence (4), even when the communication has been interrupted, the server 310 stores the process content till the current time without deleting. In sequence (5), the client 100 stored an address of the server 310.

The client 100 transmits a request for assigning an address to the resource router 220 at the destination of movement. The resource router 220 transmits a new address to the client 100. In sequence (8), an address is assigned from the new access point.

In sequence (9), the client 100 reconnects to the server 310. In sequence (10), the server 310 carries out a process restart to the client 100. In sequence (11), the client 100 carries out round trip time communication to the resource router 210.

In sequence (12), the resource router 210, based on the address change, identifies that the client 100 has moved. In sequence (13), information is copied in the resource router 220 at the destination of movement of the client 100.

In sequence (14), the resource router 210 transmits a response to the client 100. In sequence (15), the client 100 transmits the round trip time to the resource router 220 at the destination of movement. The resource router 220 returns the response transmission to the client 100. Moreover, according to the requirement, the server may also move according to the movement of the client 100.

As it has been described above, the network system of the first embodiment has the plurality of servers 310, 311, and 312 etc. which carry out a predetermined process, two or more than two resource routers 210, 220, and 230 which are connected to the plurality of servers 310, 311, and 312, and the client 100 which communicates with at least any one of the plurality of servers via the resource routers 210, 220, and 230. Moreover, the resource router 210, at a predetermined timing, selects and switches to a server which carries out the optimum processing for the client 100, from among the plurality of servers. Here, a system may be of only one resource router 210.

Accordingly, it is possible to provide a network system which is capable of carrying out the processing most efficiently all the time, by selecting the optimum server according to the circumstances, when the client 100 has moved.

Furthermore, in the first embodiment, when the resource router which the client 100 is connected, is switched one after another with the movement of the client 100, the resource router connected to the client 100, based on connection information when the other resource router was connected to the client, selects a server which carries out the optimum processing for the client 100. Accordingly, the processing is not interrupted.

### Second Embodiment

Next, a network system according to a second embodiment of the present invention will be described below. Same reference numerals are assigned to components which are same as in the first embodiment, and repeated description of such components is omitted.

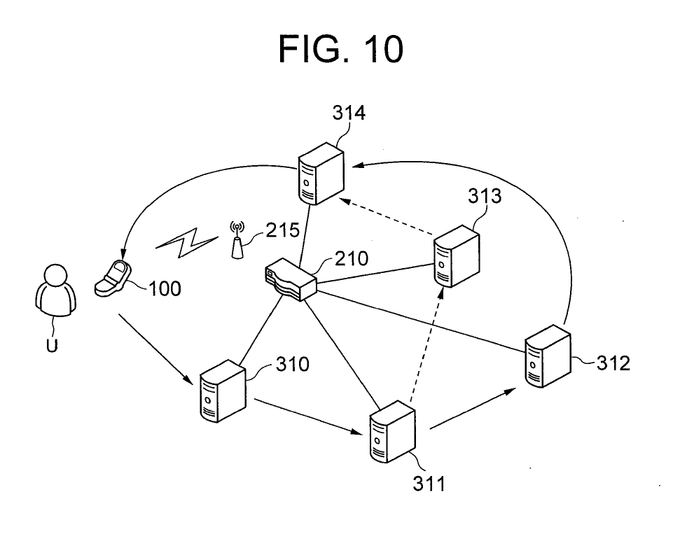

FIG. 10 is a diagram showing a schematic structure of the network system according to the second embodiment. In the second embodiment, a plurality of servers is connected in series. Moreover, an arrangement is made such that the server to be used is switched when one processing is carried out in all.

A case in which, the plurality of servers is connected in series, and one processing is carried out in all is taken into consideration. As processing, compressing an RGB image to JPEG format is taken into consideration. The JPEG compression process is divided into the following four stages.

(1) Conversion from RGB to YCbCr

(2) Down sampling

(3) DCT and quantization

(4) Huffman coding

Moreover, the following processes are assigned to the servers.

Server 310 RGB→YCbCr conversion

Server 311 Down sampling

Server 312 DCT and quantization

Server 313 DCT and quantization

Server 314 Huffman coding

The client 100 transmits an RGB image to the server 310. An output of the server 310 is input to the server 311. An output of the server 311 is input to the server 312. In this manner, the data is received and passed on serially from one server to another server. Moreover, the client 100 receives an output of the server 314, and the JPEG image is achieved.

At a point of time of start of the processing, the resource router 210 has assigned DCT and quantization to the server 312. However, thereafter, the status of network load and server change, and it is assumed that the resource router 210 has made a determination that the processing becomes faster when the server 313 is assigned to the DCT and quantization. At this time, by the same procedure as of switching of the server by the client, the server which carries out DCT and quantization is switched. Accordingly, the output of the server 311 is input to the server 313. Moreover, an output of the server 313 is input to the server 314. Furthermore, it is possible to carry out the processing efficiently.

### Third Embodiment

Next, a network system according to a third embodiment of the present invention will be described below. Same reference numerals are assigned to components same as in the first embodiment, and repeated description is omitted.

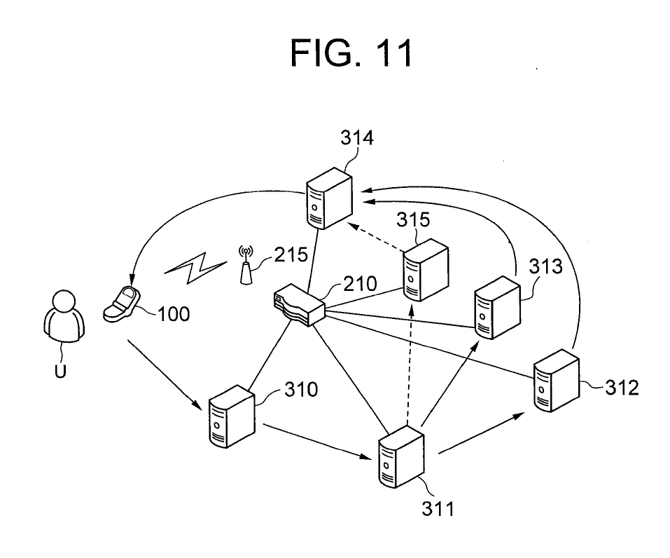

FIG. 11 shows a schematic structure of the network system according to the third embodiment. In the third embodiment, a plurality of servers including servers connected in parallel is connected in series. Moreover, an arrangement is made such that, the server to be used is switched at the time of carrying out one process in all.

In an example of processing (JPEG image) same as in the second embodiment, the servers are inserted in parallel half way of the path. The DCT and quantization processing is assigned to the server 312 and the server 313. The DCT and quantization enables to divide an image into two parts namely an upper image and a lower image, and to carry out the processing for two parts respectively. The server 312 carries out DCT and quantization for the upper half of the image. The server 313 carries out DCT and quantization for the lower half of the image.

An output after down sampling of the server 311 is input to the server 312 and the server 313. An output result of DCT and quantization is collected in the server 314.

Moreover, it is assumed that resource router has made a determination that the processing can be faster when the server 315 which has not been used currently during the processing (to which, DCT and quantization processing is assigned) instead of the server 313. At this time, by the same procedure as of switching of the server by the client 100, the server which carries out DCT and quantization is switched. Accordingly, the output of the server 311 is input to the server 312 and the server 315. According to the third embodiment, it is possible to carry out the processing efficiently.

The present invention is widely applicable to a grid computing and a cluster computing. In this manner, the present invention can have various modified embodiments which fairly fall within the basic teachings herein set forth.

### INDUSTRIAL APPLICABILITY

As it has been described above, the network system according to the present invention is suitable for a network system for (in) a situation in which the client moves.

1. A network system comprising:
a plurality of first arithmetic processing units which carry out a predetermined processing;
a second arithmetic processing unit which is connected to the plurality of first arithmetic processing units; and
a third arithmetic processing unit which communicates with at least one of the plurality of first arithmetic processing units via the second arithmetic processing unit, wherein
the second arithmetic processing unit, at a predetermined timing, selects and switches to the first arithmetic processing unit which carries out an optimum processing with respect to the third arithmetic processing unit, from among the plurality of first arithmetic processing units.

2. A network system comprising:
a plurality of first arithmetic processing units which carry out a predetermined processing;
two or more second arithmetic processing units which are connected to the plurality of first arithmetic processing units; and
a third arithmetic processing unit which communicates with at least one of the plurality of first arithmetic processing units via the second arithmetic processing unit, wherein
the second arithmetic processing unit, at a predetermined timing, selects and switches to the first arithmetic processing unit which carries out an optimum processing with respect to the third arithmetic processing unit, from among the plurality of first arithmetic processing units.

3. The network system according to claim 2, wherein
when the second arithmetic processing unit to which the third arithmetic processing unit connects is switched one after another, with a movement of the third arithmetic processing unit, the second arithmetic processing unit which is connected to the third arithmetic processing unit, based on connection information when another second arithmetic processing unit was connected to the third arithmetic processing unit, selects the first arithmetic processing unit which carries out an optimum processing with respect to the third arithmetic processing unit.

4. The network system according to claim 1, wherein the first arithmetic processing unit passes data to one of the other first arithmetic processing units.

5. The network system according to claim 2, wherein the first arithmetic processing unit passes data to one of the other first arithmetic processing units.

6. The network system according to claim 1, wherein the first arithmetic processing unit passes data to the plurality of the other first arithmetic processing units.

7. The network system according to claim 2, wherein the first arithmetic processing unit passes data to the plurality of the other first arithmetic processing units.
